(19) United States
(12) Patent Application Publication
(10) Pub. No.: US 2024/0360750 A1
(43) Pub. Date: Oct. 31, 2024

(54) JOB PLANNER FOR IMAGING TOOLS

(71) Applicant: Halliburton Energy Services, Inc., Houston, TX (US)

(72) Inventors: Ahmed Elsayed FOUDA, Pearland, TX (US); Baris Guner, Houston, TX (US)

(73) Assignee: Halliburton Energy Services, Inc., Houston, TX (US)

(21) Appl. No.: 18/140,844

(22) Filed: Apr. 28, 2023

(51) Int. Cl. E21B 47/002

(52) U.S. Cl. CPC E21B 47/0025; E21B 2200/20

(57) ABSTRACT

Aspects of the subject technology relate to systems, methods, and computer readable media for simulating a tool response. A synthetic formation can be generated based on one or more imaging properties. A tool response of an imaging tool operating according to one or more operational parameters can be simulated to generate a synthetic tool response. A change to at least one of the one or more imaging properties and the one or more operational parameters can be identified. The tool response of the imaging tool operating according to the change can be simulated to generate a modified synthetic tool response. A representation of the modified synthetic tool response can be reproduced to show an effect of the change to at least one of the one or more imaging properties and the one or more operational parameters on the tool response of the imaging tool.

### TECHNICAL FIELD

The present technology pertains to simulating imaging tool performance, and more particularly, to simulating the tool response of an imaging tool to changes to imaging properties and operational parameters.

### BACKGROUND

Various imaging tools, such as electromagnetic imaging tools have been developed for generating images downhole in wellbores. In particular, such tools can characterize properties of a formation as part of imaging downhole in wellbores. A large number of operational parameters can be controlled in operating the imaging tools. However, it can be difficult to select proper values for the operational parameters for controlling the imaging tools in imaging a formation. In particular, a large number of geological variables can define a formation and ultimately affect operation of the imaging tools. Furthermore, wellbore properties including the mud filling the borehole may show a large variation. As such, the large number of geological and borehole related variables and variance of such variables across different wellbores make it difficult to select proper values for operational parameters of imaging tools.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology;

FIG. 1B is a schematic diagram of an example downhole environment having tubulars, in accordance with various aspects of the subject technology;

FIG. 2A illustrates a perspective view of a LWD electromagnetic imaging tool.

FIG. 2B illustrates another perspective view of the LWD electromagnetic imaging tool.

FIG. 2C illustrates yet another perspective view of the LWD electromagnetic imaging tool.

FIG. 3 shows an example current density generated by the electromagnetic sensor of the LWD electromagnetic imaging tool operating to measure a formation.

FIG. 4 illustrates a schematic diagram of an example pad of an electromagnetic imaging tool, in accordance with various aspects of the subject technology;

FIG. 5 illustrates a circuit model of the example pad illustrated in FIG. 4, in accordance with various aspects of the subject technology;

FIG. 6 is a plot of impedances measured by the electromagnetic imaging tool versus formation resistivity Rₜ., in accordance with various aspects of the subject technology;

FIG. 7 is a graph of the absolute value of the measured impedance versus the formation resistivity that corresponds to the measurements shown in FIG. 6, in accordance with various aspects of the subject technology;

FIG. 8 illustrates a flowchart for an example method of simulating a tool response in a synthetic formation according to either or both changing imaging properties and changing operational parameters of the tool, in accordance with various aspects of the subject technology;

FIG. 9A is a graph of an example of a resistivity profile of a synthetic medium, in accordance with various aspects of the subject technology;

FIG. 9B is a graph of a relative permittivity profile of the synthetic medium, in accordance with various aspects of the subject technology;

FIG. 9C is a standoff profile of the synthetic medium in conjunction with an electromagnetic imager tool operating in the synthetic medium, in accordance with various aspects of the subject technology;

FIG. 10A illustrates a schematic representation of an experiment setup for generating a tool response, in accordance with various aspects of the subject technology;

FIG. 10B illustrates a schematic representation of an alternative experiment setup for generating a tool response, in accordance with various aspects of the subject technology;

FIG. 11A is a graph of an example of a resistivity profile of a synthetic medium that is generated based on the resistivity profile shown in FIG. 9A using the nearest neighbor approach, in accordance with various aspects of the subject technology;

FIG. 11B is a graph of a relative permittivity profile of the synthetic medium that is generated based on the relative permittivity profile shown in FIG. 9B using the nearest neighbor approach, in accordance with various aspects of the subject technology;

FIG. 11C is a standoff profile of the synthetic medium in conjunction with an electromagnetic imager tool operating in the synthetic medium using the nearest neighbor approach, in accordance with various aspects of the subject technology;

FIG. 12 illustrates an example GUI 1200 for controlling synthesis of a formation and simulation of a tool response in the synthesized formation, in accordance with various aspects of the subject technology; and

FIG. 13 illustrates an example computing device architecture which can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

As discussed previously, various imaging tools, such as electromagnetic imaging tools have been developed for generating images downhole in wellbores. In particular, such tools can characterize properties of a formation as part of imaging downhole in wellbores. A large number of operational parameters can be controlled in operating the imaging tools. However, it can be difficult to select proper values for the operational parameters for controlling the imaging tools in imaging a formation. In particular, a large number of geological variables can define a formation and ultimately affect operation of the imaging tools. Furthermore, the properties of the wellbore, including the mud circulating within the wellbore, may exhibit significant variation. As such, the large number of geological and borehole related variables and variance of such variables across different formations make it difficult to select proper values for operational parameters of imaging tools.

The disclosed technology addresses the foregoing by providing a job planner for downhole imaging tools. Specifically, a job planner can help predict tool performance by running processing algorithms on synthetic or experimental data that simulates the conditions for an upcoming job. Further, the job planner can simulate and help identify values of operational parameters associated with an imaging tool.

The job planner can model realistic formation geologies with different properties, such as in the case of resistivity imaging tools, resistivity, permittivity, standoff, dispersion, dielectric loss values, and muds with different compositions. A representative formation environment can be simulated for a well that can be logged. Further, users can provide input, e.g. by drawing or entering the values of the parameters of the formation layers themselves, for simulating the formation. Additionally, formation properties can be obtained from offset wells to simulate the formation. Formation and borehole related properties can be adjustable by users for various reasons, e.g. to adjust rugosity of a borehole, add features such as vugs, breakouts, and fractures, and adjust sizes and properties of the features. Operation of the tool according to varying operational parameters can be simulated in the represented formation and the effects of such varying operational parameters can be reproduced for a user, e.g. through a graphical user interface (“GUI”). Responses of tools at varying operational parameters can be simulated either through synthetic data or experimental data. Specifically, interpolation can be applied to existing responses to simulate cases that do not match existing data points, or the response of the nearest match among the existing ones can be used. Quantitative estimation algorithms can also be integrated with the job planner to better predict tool performance, e.g. for varying tool parameters for a specific job.

The technology is described herein with respect to an electromagnetic imaging tool. However, the technology, as described herein, can be applied for an applicable downhole imaging tool, such as an applicable oil-based mud electromagnetic imager, an applicable water-based mud electromagnetic imager, an acoustic imager, and a density imager.

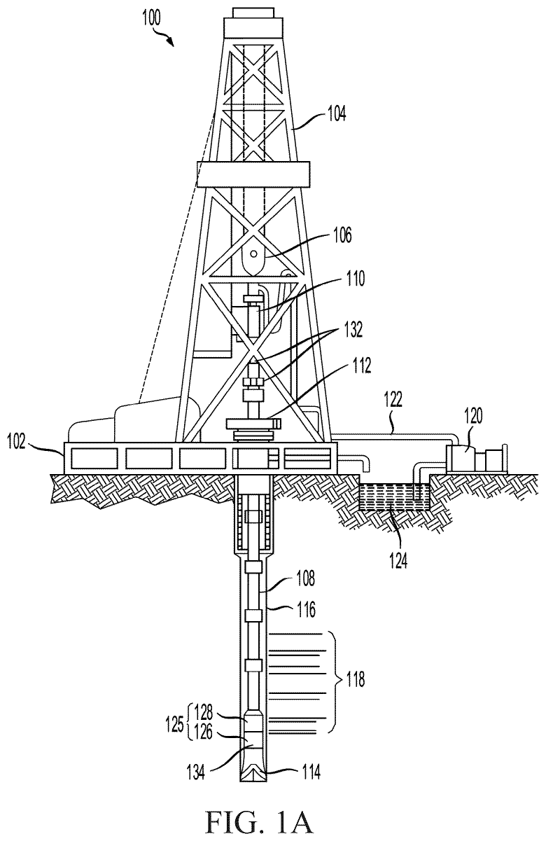

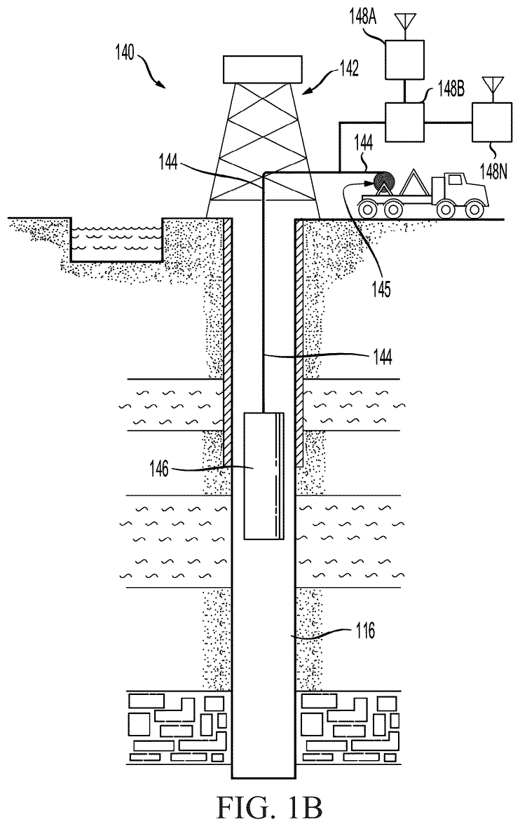

Turning now to FIG. 1A, a drilling arrangement is shown that exemplifies a Logging While Drilling (commonly abbreviated as LWD) configuration in a wellbore drilling scenario 100. Logging-While-Drilling typically incorporates sensors that acquire formation data. Specifically, the drilling arrangement shown in FIG. 1A can be used to gather formation data through an electromagnetic imaging tool as part of logging the wellbore using the electromagnetic imaging tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As both the drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imaging tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission. e.g, using mud pulse telemetry, EM telemetry, or acoustic telemetry. In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

Referring to FIG. 1B, an example system 140 is depicted for conducting downhole measurements after at least a portion of a wellbore has been drilled and the drill string removed from the well. An electromagnetic imaging tool can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imaging tools described herein.

The illustrated wireline conveyance 144 provides power and support for the tool, as well as enabling communication between data processors 148A-N on the surface. In some examples, the wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via the wireline conveyance 144 to meet power requirements of the tool. For slickline or coiled tubing configurations, power can be supplied downhole with a battery or via a downhole generator.

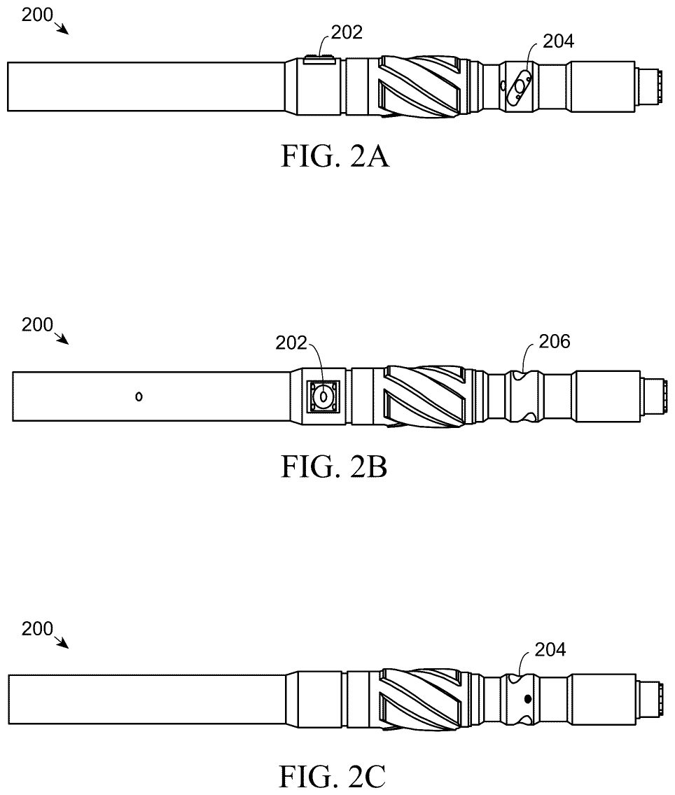

FIG. 2A illustrates perspective view of a LWD electromagnetic imaging tool 200. FIG. 2B illustrates another perspective view of the LWD electromagnetic imaging tool 200. FIG. 2C illustrates yet another perspective view of the LWD electromagnetic imaging tool 200. The LWD electromagnetic imaging tool 200/mud imaging tool can be integrated as part of an applicable LWD drilling system, such as the logging tools 126 in the LWD scenario 100 shown in FIG. 1A.

The LWD electromagnetic imaging tool 200 includes an electromagnetic sensor 202 disposed along a collar of the LWD electromagnetic imaging tool 200. The LWD electromagnetic imaging tool 200 shown in FIGS. 2A-2C also includes first and second ultrasonic transducers 204 and 206, however and in various embodiments, a LWD electromagnetic imaging tool 200 does not have ultrasonic transducers disposed along the collar. Specifically, the LWD electromagnetic imaging tool 200 shown in FIGS. 2A-2C is merely an example of a LWD electromagnetic imaging tool 200, and in various embodiments, a LWD electromagnetic imaging tool 200 can have a different design. Specifically, a water-based mud LWD electromagnetic imaging tool may have similar designs, and can provide less design and interpretation complications than oil-based mud LWD electromagnetic imaging tools, e.g. due to the conductive nature of water-based mud.

LWD electromagnetic imaging tools can provide a high resolution image of the formation surrounding a borehole, e.g. when compared to other borehole imaging tools. As a result, LWD electromagnetic imaging tools can be used to identify damaged borehole sections, provide a better knowledge on the thin beds, and also provide images that can be used to determine the dip angle of formation bed.

The sensor topology of LWD electromagnetic imaging tools operating in a LWD environment should have minimum complexity, and more importantly, it should not rely on borehole contact. With respect to the LWD electromagnetic imaging tool 200 shown in FIGS. 2A-C, the electromagnetic sensor 202 can include a single measurement (also called probe, button or current) electrode mounted on the side of the collar. The electromagnetic sensor 202 can be disposed on the collar such that it is located at a certain distance, also known as standoff, from a borehole wall during operation of the LWD electromagnetic imaging tool. Further, the electromagnetic sensor 202 can include a guard electrode that surrounds, at least a portion of the button electrode. This electrode may be excited by an alternating current, sine-wave generator, and it may be coupled to the formation through a mud, e.g. an oil-based mud. This mud is non-conductive for oil-based muds. As a result, the coupling to the formation is accomplished through displacement currents in the mud. This arrangement provides a low sensitivity to standoff changes in resultant microresistivity image.

In operation of the LWD electromagnetic imaging tool 200, a measurement current enters the formation, which may have a much lower resistivity than the mud. In the formation, the current flows by conduction and penetrates the formation. The current then returns back toward the borehole where it returns to the body of the LWD electromagnetic imaging tool 200 surrounding the electromagnetic sensor 202, e.g. the tool body serves as the return electrode for the LWD electromagnetic imaging tool 200. The tool body can remain at ground potential because of its large surface area.

Imaging through the LWD electromagnetic imaging tool 200 can be achieved by dividing gathered data/measurements into azimuthal bins as the LWD electromagnetic imaging tool 200 rotates in the borehole during drilling. The LWD electromagnetic imaging tool can also include an additional mud resistivity sensor, e.g. a mud cell. In imaging through the LWD electromagnetic imaging tool 200, real components of the measurements made by the electromagnetic sensor 202 can be used to determine formation resistivity. Further, mud resistivity measurements made by the mud resistivity sensor can be used to improve the determined formation resistivity measurements.

The LWD electromagnetic imaging tool 200 can be a multi-frequency tool. Specifically, the LWD electromagnetic imaging tool 200 can operate at multiple frequencies in gathering measurements. For example, a higher frequency in the MHz range may be used to overcome the nonconductive nature of oil-based muds in generating measurements while a lower frequency in the 100 kHz range may be more sensitive to standoff and thus may be used in standoff determination. Further, gathered standoff information may be used to identify features in the formation. For example, a thin band of increased resistivity can be due to an opening in the rock. In turn, this can be reflected as a jump in apparent standoff.

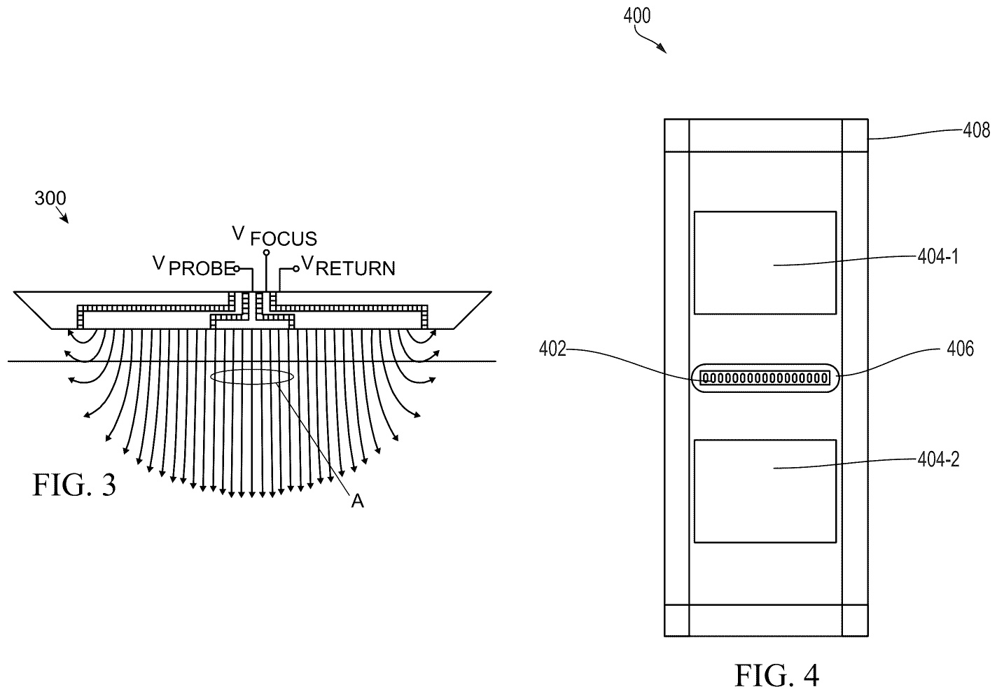

FIG. 3 shows an example current density 300 generated by the electromagnetic sensor 202 of the LWD electromagnetic imaging tool 200 operating to measure a formation. A power source drives a voltage between the return electrode, whose voltage with respect to the ground is represented through Vᵣₑₜᵤᵣₙ and the probe electrode, whose voltage with respect to a ground is represented by V_{probe}. Further, a circuitry is implemented to keep V_{probe} equal, or roughly equal, to V_{focus} for focusing of the measurement current. The current transmitted from the electromagnetic sensor is measured, for example through the use of a toroid. The ratio of the voltage difference between probe and return to the transmitted current is used to calculate a measured impedance. A basic circuit theory based model that relates the measured impedance to formation and mud parameters that is applicable to both LWD and wireline tools will be provided after a discussion on wireline electromagnetic tools.

The discussion now continues with a discussion of wireline electromagnetic imaging tools. FIG. 4 illustrates a schematic diagram of an example pad 400 of a wireline electromagnetic imaging tool, as described above in FIG. 1B. Specifically, the wireless electromagnetic imaging tool can be integrated with the tool body 146 of the downhole tool in FIG. 1B. More specifically, the pad 400 can be disposed on an outer surface of the tool body 146 to make measurements as the downhole tool is operated within the wellbore. The electromagnetic imaging tool functions to gather measurements while logging a wellbore, e.g. for purposes of imaging a formation surrounding the wellbore. Specifically, the electromagnetic imaging tool can operate in a drilling mud to gather measurements for imaging the formation surrounding the wellbore. The electromagnetic imaging tool can operate in an applicable type of drilling mud, such as an oil-based mud or a water-based mud, to log the wellbore. Oil-based muds have much higher resistivities than water-based muds. Therefore, the mud effect is much stronger for measurements made in oil-based muds. In operating to log the wellbore, the electromagnetic imaging tool can gather applicable measurements that are capable of being measured by the electromagnetic imaging tool. For example, measurements made by the electromagnetic imaging tool can include apparent impedivity and impedance measurements at the electromagnetic imaging tool, complex impedance measurements at the electromagnetic imaging tool, voltage measurements at the electromagnetic imaging tool, current measurements at the electromagnetic imaging tool, phase measurements at the electromagnetic imaging tool, and absolute values of impedance measurements at the electromagnetic imaging tool.

The measurements gathered by the electromagnetic imaging tool can be used to identify values of formation and mud properties, otherwise referred to as imaging properties, associated with the electromagnetic imaging tool, e.g. parameters inside of and outside of the wellbore. Imaging properties include applicable parameters that can be identified from measurements taken by the electromagnetic imaging tool for purposes of imaging, e.g. through the wellbore. Further, imaging properties can include applicable properties of a wellbore and a formation in which the wellbore is formed that ultimately affect imaging or logging of the formation through the wellbore. For example, imaging properties can include mud permittivity, mud resistivity, standoff, formation permittivity of a formation of the wellbore, and formation resistivity of the formation of the wellbore. The values of the imaging properties can be identified using the techniques described herein on a per-button basis for wireline imaging. For example, formation resistivity, formation permittivity, mud resistivity, mud permittivity and standoff values can be identified for each button included as part of a button array 402 of a pad 400. For LWD imaging, measurements are generally obtained using a single button electrode. In that case, azimuthal coverage is obtained by dividing the measurements into azimuthal bins as the tool rotates. Thus, these azimuthal bins in an LWD tool serves the same purpose with the measurements made by multiple button electrodes spaced circumferentially around the tool in a wireline tool. Although the origin of the measurements are different in LWD and wireline tools, the processing methods described herein equally applies to both type of tools.

In operating the wireline electromagnetic imaging tool to gather measurements for imaging, a voltage difference can be applied across the button array 402 and first and second return electrodes 404-1 and 404-2 (return electrodes 404) of the pad 400. This voltage difference can generate currents that pass from the button array 402 into the mud and a surrounding formation. The pad 400 also includes a guard electrode 406 around the button array 402. The same potential that is applied to the button array 402 can be applied to the guard electrode 406 to focus all or a substantial portion of the current emitted into the mud and the surrounding formation. Specifically, the current can be emitted substantially radially into the surrounding formation by applying the same potential on the guard electrode 406 and the button array 402. An applicable electrical and/or thermal insulating material, such as a ceramic, can fill the remaining portions of the pad 400. For example, a ceramic material can be disposed between the return electrodes 404 and the guard electrode 406. The pad 400 is covered, at least in part, with a housing 408. The housing 408, and accordingly the pad 400 through the housing 408, can be connected through a securing mechanism to a mandrel. The securing mechanism can be a movable mechanism that moves the housing 408 and the contained pad 400 to substantially maintain contact with the formation. For example, the securing mechanism can include an arm that opens and/or swivels to move the housing 408 and the contained pad 400. By moving the housing 408 and the contained pad to maintain a good contact with the formation, the mud effect can be minimized for wireline imaging tools.

Turning back to a discussion of the mud effect and its impact on electromagnetic imaging tools, the mud effect, as described previously, refers to the contribution of the mud to the measured impedance. Further and as discussed previously, this effect is particularly severe if a formation exhibits low resistivity and the distance between the button electrode's outer surface and the borehole wall, e.g. the formation, is high. In those instances, measured impedance may have very low sensitivity to the formation features. Maintaining good contact between the pad 400 and the formation can help wireline imaging tools to ensure that the electromagnetic imaging tool actually measures the formation and not just the mud when the formation has low resistivity. Since mud effect is a function of standoff, the term standoff effect may be used interchangeably with mud effect in what follows.

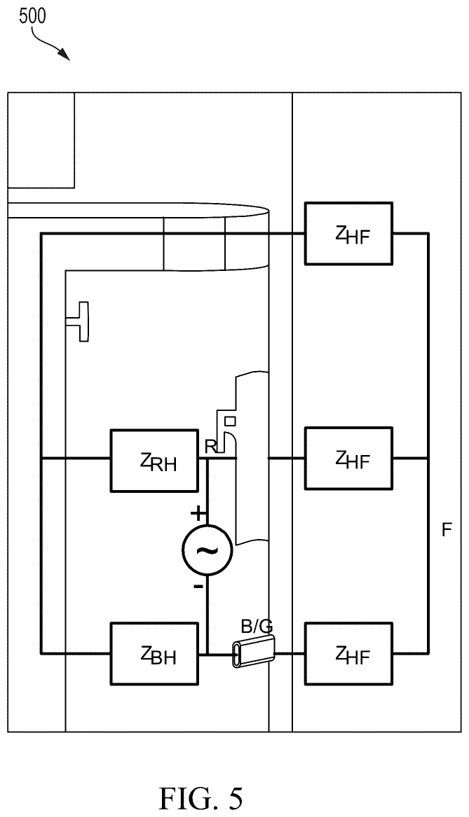

FIG. 5 illustrates a circuit model of the example pad 400 illustrated in FIG. 4. Although the exact design of the tool is different for LWD tools, as described with respect to FIGS. 2A-3, the equations derived for the circuit model shown in FIG. 5 are applicable for LWD tools. In the model, H denotes the housing (including the mandrel), F denotes the formation, either B or G denotes the button and guard assembly, and R denotes the return signal from the formation and/or the mud. While most of the transmitted current can be returned to the return electrodes, some portions of the transmitted current can return through the housing and/or the mandrel. An impedance value for each button can be calculated by measuring the voltage between the buttons and the return electrodes and dividing the measured voltage by the current transmitted through each button of the button array. Specifically, this technique is represented in Equation 1 shown below. In Equation 1, Z is the button impedance of one of the buttons in the button array, V_{BR} is the button to return voltage, and IB is the button current. With respect to the LWD tools described in FIGS. 2A-C and FIG. 3, V_{BR} can be replaced with the probe to return voltage, and IB can be replaced with the current of the probe.

$$Z = \frac{{V}_{BR}}{{I}_{B}} \qquad Equation 1$$

A calculated button impedance, e.g. calculated by Equation 1, can be equal to the impedances of the button and guard assembly and the formation Z_{BF} and the impedances of the return and the formation Z_{RF}, as shown in the circuit model in FIG. 5. While Z_{BF} and Z_{RF} are denoted with respect to the formation F, Z_{BF} and Z_{RF} can have contributions from both the mud and the formation. Thus, Z_{BF} can equivalently be represented by Equation 2 shown below.

$$Z \approx {Z}_{BF} = {Z}_{mud} + {Z}_{F} \qquad Equation 2$$

Accordingly, a measured button impedance, as shown in Equation 2, can have contributions from both the mud and the formation. If the imaginary parts of Z_{F} and Z_{mud} are mainly capacitive, and assuming this capacitance is in parallel with the resistive portion, Z_{BF} can also be written as shown in Equation 3 below.

$${Z}_{BF} = \frac{1}{( \frac{1}{{R}_{M}} + j ω {C}_{M} )} + \frac{1}{( \frac{1}{{R}_{F}} + j ω {C}_{F} )} \qquad Equation 3$$

In Equation 3, R and C denote the resistance and capacitance and ω is the angular frequency (e.g. ω=2πf where f is the frequency in Hz). In Equation 3, subscript M denotes the mud while F denotes the formation. Both the mud resistance and mud capacitance can increase with standoff and decrease with the effective areas of the buttons.

Equation 3 can provide just a basic approximation to the impedance measured by the electromagnetic imaging tool. However, Equation 3 can be useful in illustrating the effects of mud and formation properties on the measured impedance. Specifically, from Equation 3, it can be deduced that high frequencies are needed to reduce the mud contribution to the measured impedance.

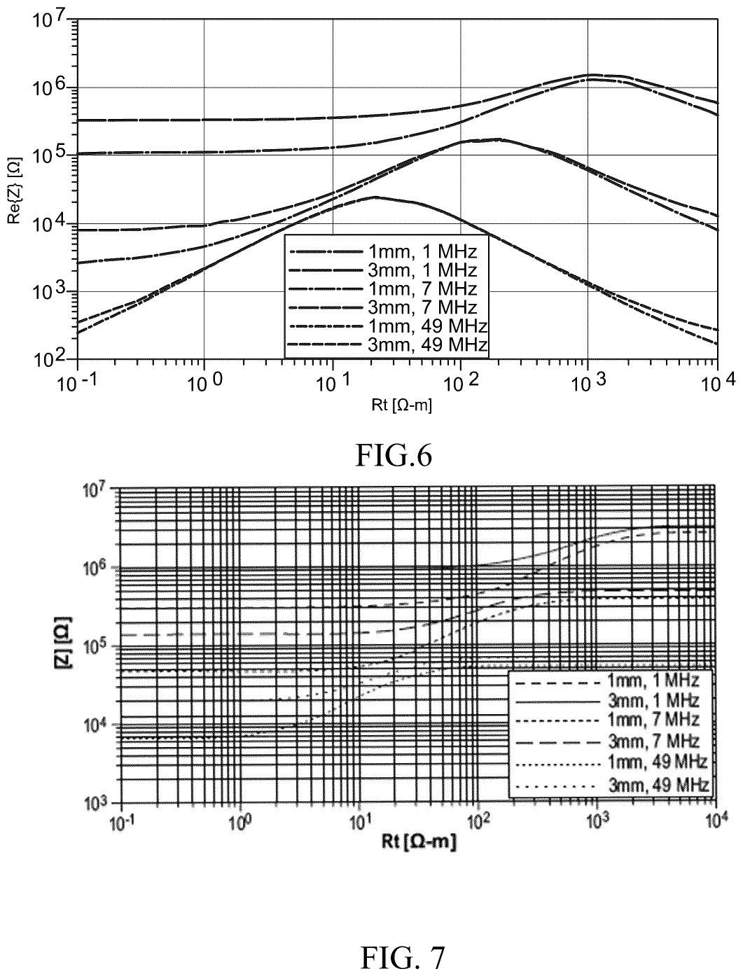

Equation 3 can also be used to obtain basic performance curves for an imager tool which are fairly accurate in homogeneous formations. FIG. 6 is a graph of the real parts of measured impedance gathered by an electromagnetic imaging tool versus the formation resistivity is shown. The imaginary part of the impedance can be significantly impacted by the mud capacitance, therefore it is not plotted in this disclosure. It is assumed that formation permittivity (ε_{F}) is 15, mud permittivity (ε_{M}) is 6 and mud resistivity (ρ_{M}) is 8000 Ω-m. Results for three different frequencies (1 MHZ, 7 MHz and 49 MHz) at 2 different standoffs (1 mm and 3 mm) are shown. Standoff can include the distance of the pad's outer surface from the borehole wall.

As shown in FIG. 6, it is not straightforward to interpret the response of the tool. Specifically, the tool response does not vary linearly with formation resistivity. Instead, it is a complicated function of formation and mud properties (resistivity and permittivity) as well as the standoff. The dominant effect at low formation resistivities and low frequencies can be the standoff effect. Small variations in standoff can cause a large difference in the impedance reading if these raw measurements are used. For the high formation resistivities and high frequencies, formation permittivity can start to have the greatest contribution to the measured impedance. This can cause the apparent resistivity curve to decrease after a certain formation resistivity (the resistivity value where this effect starts to show up is formation and tool dependent); thus, it is called the dielectric roll-off.

FIG. 7 is a graph of the absolute value of the measured impedance versus the formation resistivity that corresponds to the measurements shown in FIG. 6. As shown in FIG. 7, the absolute value of the impedance does not suffer a roll-off due to the dielectric effect at high formation resistivities. However, the sensitivity of the tool to resistivity can be greatly reduced, as is shown by the absolute value of the impedance being almost flat with changing formation resistivity.

The disclosure now further continues with a discussion of job planner technology for imaging tools, such as the electromagnetic imaging tools discussed with respect to FIGS. 3 through 7. As shown through the previous discussion, mud can significantly affect the performance of an oil-based mud imaging tool at low formation resistivities while the dielectric effect due to the permittivity of the formation can be more significant at high formation resistivities. These effects can be reduced by an appropriate choice of values for operational parameters, e.g. the operating frequencies, of the tool. However, there can be a limit on the number of frequencies that a tool may employ, e.g. because of limits on the data that can be transmitted uphole in real-time. Alternatively, data can be saved downhole, but even in such a case, hardware constraints can limit the number of frequencies in most practical applications to less than 5.

The effects of standoff are exacerbated under certain conditions. For example, if proper pad pressure is not applied, pads can experience larger variations in standoff and occasional loss of contact with the borehole wall. In a rugose borehole, high impedance can be seen by the transmitters, thereby increasing power requirements for transmission by the transmitters. Further, higher logging speeds can lower signal-to-noise ratios and decrease the resolution of the tool.

Applicable operational parameters, including the previously described operational parameters may be selected through the help of a job planner that implements the technology described herein, effectively optimizing the operational parameters for a given tool operating in a given formation. Operational parameters, as used herein, include applicable parameters that can be varied in relation to operation of a downhole imaging tool for a specific imaging job. For example, operational parameters can include, e.g. in the case of an electromagnetic imaging tool, the operating frequencies, logging speeds, pad pressures, pad to curvature mismatch, and power requirements. Operational parameters can also include selection of an appropriate pad curvature, e.g. based on the bit size used in the wellbore.

Furthermore, other effects can be visualized to improve the understanding of tool's response and assist in interpretation of the measurements. For example, different environments can have different amounts of thermal noise which may affect the image quality. It may be possible to simulate the effect of noise on the expected responses using the proposed job planner. Noise may be added to the tool response as will be described later. Amount of uncertainty for a given noise level may be computed from the deviation of the results of a quantitative estimation process which will also be described in detail later for the case with noise from the results for the case with no noise. This in turn may be used to aid the selection of the operational frequencies of the imaging tool as previously discussed. Effect of differences in curvature between pad and the tool may also be visualized.

The job planner can also be configured to account for varying imaging properties. Imaging properties can include applicable parameters that define or otherwise characterize a formation in which an imager tool operates downhole. Such imaging properties can be human controlled parameters that create features within the formation. Example imaging properties include formation properties such as vugs, breakouts and fractures that can define a formation and affect a tool response in operating to image in the formation. Imaging properties can also include applicable parameters that are related to creation of a wellbore in a formation and ultimately define the wellbore within the formation. For example, imaging properties can include mud properties including varying mud permittivity, varying mud resistivity, and varying mud oil-to-water ratio related to the type of mud used in a particular well an affect how imaged feature look. In most cases, a borehole can already be selected with a specific mud. For those cases, it can be instructive to inspect how different formation features look at different operating frequencies for the specific mud used in the well. In other cases, the job planner may be utilized to select a specific mud using in drilling a wellbore in a formation. Thus, analysts may visualize the expected responses for the given imaging parameters and use these expected responses to select the operational parameters that lead to a more straight forward interpretation while satisfying other requirements such as logging time and power consumption. Further, this can provide aid to analysts in interpretation of images.

Analysts may more easily discern the underlying causes that produce the observed features once the actual imaging log is obtained once equipped with a tool that show the expected response for given operational parameters and imaging properties as well. This tool may aid analysts in understanding the underlying geology, pinpointing possible issues and their root causes, as well as determining the noise level of the environment.

Described job planner may also be used for educational purposes to get image analysts better acquainted with a specific imaging tool for a variety of conditions and help improve their interpretation skills. An instructor may explain the different components of the job planner GUI and may demonstrate how the raw response and quantitative estimation results vary under different scenarios. To ensure repeatability in those scenarios, users may be given the option to set the seed of the random media generator.

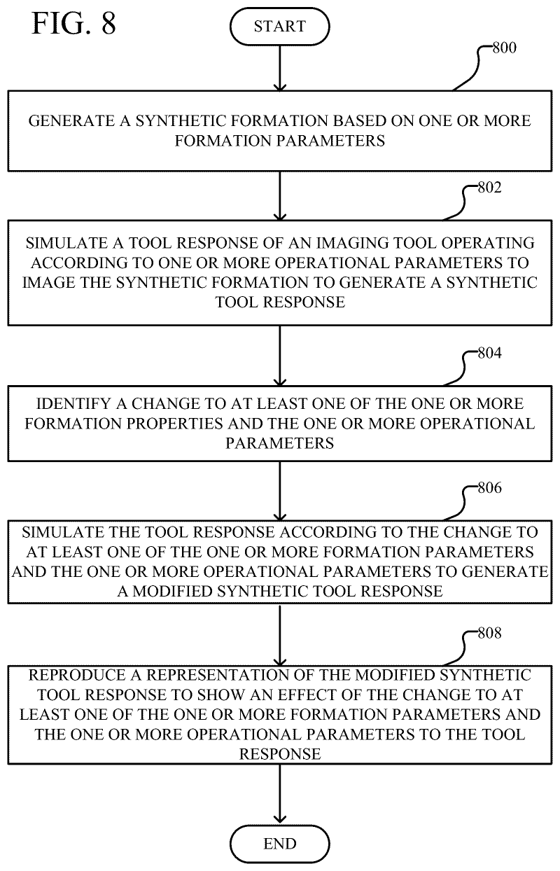

FIG. 8 illustrates a flowchart for an example method of simulating a tool response in a synthetic formation according to either or both changing imaging properties and changing operational parameters of the tool. The method shown in FIG. 8 is provided by way of example, as there are a variety of ways to carry out the method. Additionally, while the example method is illustrated with a particular order of steps, those of ordinary skill in the art will appreciate that FIG. 8 and the modules shown therein can be executed in any order and can include fewer or more modules than illustrated. Each module shown in FIG. 8 represents one or more steps, processes, methods or routines in the method.

At step 800, a synthetic formation based on one or more imaging properties is generated. Imaging properties, as will be discussed in greater detail later can be selected based on input received from a user. Specifically, a user can provide input regarding values of imaging properties to use in synthesizing a formation through a GUI. For example, a user can provide mud properties for forming a wellbore in a formation that ultimately affect characteristics of the image and features within the image. The response of the tool to the synthetic formation implemented through a formation generator and the other imaging properties and operational parameters can be simulated using an applicable technique. Specifically, the response of the imaging tool can be simulated through application of one or more applicable models. Further, the response of the tool can be simulated based on data from one or more reference logs. For example, a reference log of actual measurements made in a specific formation or an adjacent formation to the specific formation can be used in simulating the response of the tool.

At step 802, a tool response of an imaging tool operating according to one or more operational parameters to image the synthetic formation is simulated to generate a synthetic tool response. Specifically, values of operational parameters can be selected for a given job. More specifically, a user can provide input related to selection of values of operational parameters for a given job. For example, a user can specify operation frequencies. Then, operation of the imaging tool in the synthetic formation is simulated for the given mud properties and according to the selected operational parameter values. The tool response can be simulated through an applicable technique. Specifically, the tool response can be simulated through application of one or more models. For example, the tool response can be simulated through a forward model. The forward model can be run on-demand using a simulation code. Further, the forward model can be applied based on previous simulation results from one or more imaging tools. Additionally, the tool response can be simulated based on previous experimental measures. For example, previous measurements generated in simulating the tool response in previous versions of the simulated formation can be used in simulating a current tool response of the tool.

As will be discussed in greater detail later, the synthetic formation generated at step 800 can be implemented through a random or pseudo-random generator. A random or pseudo-random generator can include a system that generates random or pseudo-random variations on either or both imaging properties and operational parameters. For example, a random or pseudo-random generator can generate variations on imaging properties comprising at least one of formation resistivity and complex formation relative permittivity. Tool response of the imaging tool operating to image the synthetic formation that is simulated at step 802 can be implemented through aforementioned techniques.

At step 804, a change to at least one of the one or more imaging properties and the one or more operational parameters is identified. Changes to the imaging properties and the operational parameters can be identified based on input received from a user. For example, a user can specify to simulate a tool response in a synthetic formation at varying formation properties and varying standoff values. In turn, the formation properties and the standoff values, e.g. as part of the imaging properties, can be adjusted according to input received from the user.

At step 806, the tool response according to the change to at least one of the one or more imaging properties and the one or more operational parameters are simulated to generate a modified synthetic tool response. Specifically, the tool response can be re-simulated based on the changed imaging properties and/or operational parameters using the techniques described herein. More specifically and in the case of changed imaging properties, the synthetic formation can be altered based on the changed imaging properties to generate a modified synthetic formation. In turn, the tool response can be simulated in the modified synthetic formation. Further and in the case of changed operational parameters, the tool response can be re-simulated according to the changed operational parameters in the same synthesized formation in which the tool response was simulated. Alternatively, the tool response can be simulated according to the changed operational parameters in a modified synthetic formation that is generated based on changed imaging properties.

At step 808, a representation of the modified synthetic tool response is reproduced to show an effect of the change to at least one of the one or more imaging properties and the one or more operational parameters to the tool response. Specifically and as will be discussed in greater detail later, the simulated tool response can be presented to a user. This can allow the user to visualize the effects of changing imaging properties and/or changing operational parameters on the tool response. As follows, the user can adequately plan for an actual wellbore drilling and/or formation imaging job. Examples of plots that can be visualized include properties of the synthetic medium (if not visualized already,) raw tool response, processed tool response, and results of quantitative estimation.

As follows, the user may compare the results of the simulated tool response, e.g. of the quantitative estimation, with the ground truth data, e.g. properties of the generated synthetic medium. This can be used in quantifying performance of the tool. Further, a quality indicator can also be produced at this stage, e.g. based on the comparison of the results to the ground truth data. Additionally, the user can further tune the operational parameters and/or the imaging properties based on the raw response, processed response, quantitative estimation results, comparison of quantitative estimation results with ground-truth results, quality indicators, and the like. The parameters and properties can continue to be tuned until desired results are achieved. In turn, the job parameters can be used to guide decisions in an upcoming job, e.g. a job for which the tool response is simulated.

Alternatively or in conjunction with the flowchart shown in FIG. 8, additional imaging properties and/or operational parameters can be added. As follows, the formation can be further altered based on the additional imaging properties to generate a new or otherwise modified synthetic formation. Further, the tool response can be re-simulated in either a synthetic formation or a modified synthetic formation based on the additional operational parameters to generate the modified tool response. The additional imaging properties and the additional operational parameters can include parameters that were not selected, specified, or included in previous generations of the formation and simulations of the tool response. For example, a tool response can be simulated that does not account for varying standoff values. Subsequently, the varying standoff parameter can be applied to further generate modified simulations of the tool response.

With respect to synthesizing the formation, a GUI can be presented for generating a formation profile synthetically. Specifically, mud properties can be entered or loaded from an external file through the GUI. Mud properties can include mud resistivity, mud permittivity, and mud angle, e.g. the phase angle of the mud impedance, mud loss tangent, and other applicable properties related to mud. Mud properties may be based on a prediction of the type of mud that may be used in the well or it may be based on an actual mud measurement. Mud measurements may be made at a known temperature and the GUI may include options to enter the measurement temperature and the predicted downhole temperature. Thus, mud properties at the measurement temperature may be used to predict the mud properties at the borehole temperature. Mud properties may be determined by combining oil and water components with known properties. Mud properties may also be determined based on the oil-to-water ratio (OWR) and may be adjusted based on the predicted response obtained from the planner.

Plots of imaging properties, such as formation resistivity, formation permittivity, and standoff can be generated by a formation generator and presented to a user as part of simulating the synthetic formation. An example of a formation generator may be a random or pseudo-random media generator. Ranges of the parameters for formation generator, such as the minimum and maximum values of the formation resistivity may be entered as inputs through the GUI. Thickness and width of the features may be controlled by adjusting the correlation lengths in the GUI box.

Some of the imaging parameters may be correlated to each other. For example, it is known that formation permittivity and formation resistivity have, in general, an inverse correlation. Such correlation between properties can be used in simulating both of properties, e.g. simultaneously. Specifically, the properties can be simulated based on correlation as negatively correlated random variables. Further, the properties can be simulated by first simulating one, and then use the simulated results to obtain a scaled image of the second property. For example, formation permittivity may be generated after the generation of the formation resistivity profile by taking the reverse image of the resistivity profile and scaling the range of permittivity values so it falls withing the limits as entered by the user through the GUI.

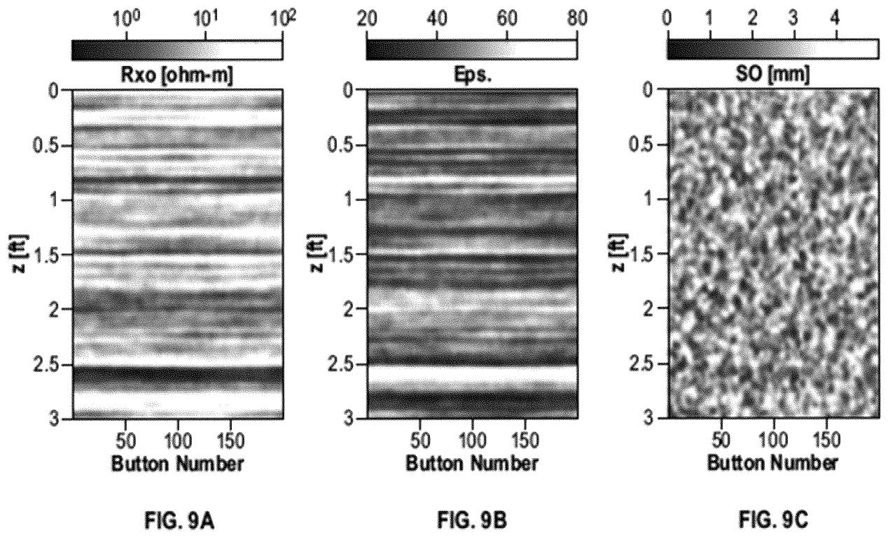

FIGS. 9A-C are representations of a synthesized formation generated using the technology described herein. Specifically, FIG. 9A is a graph of an example of a resistivity profile of a synthetic medium. FIG. 9B is a graph of a relative permittivity profile of the synthetic medium. FIG. 9C is a standoff profile of the synthetic medium in conjunction with an electromagnetic imager tool operating in the synthetic medium. As show in FIGS. 9A and 9B, resistivity and permittivity are inversely correlated.

Existing logs, or otherwise measurements, made by various imaging tools can be used in generating the synthetic formation. For example, if an image from an offset well or LWD imagers is available, selected sections of this image may be used to obtain the synthetic formation. Users may load offset wells and select the relevant section through a GUI. The data of the offset wells can be processed through quantitative estimation, a process that will be described in greater detail later. Further, the data of the offset wells can comprise raw data, or raw data passed through some processing other than quantitative estimation. The data of the offset well can be used as a proxy for the layering of the synthesized formation which may be filled with scaled formation properties within their expected range. This filling process may be done by correlating the level of the formation properties with a feature of the raw data. For example, resistivity may be correlated with the real part of the measured impedance while standoff may be correlated to the absolute value of the measured impedance. Further, layers determined from the raw data may be filled in with randomly selected or pseudo-randomly selected values within an expected range of an imaging property.

Logs generated by other tools other than the tool that is the subject of a current job plan can be used in generating the synthesized formation. For example if the synthesized formation is being created for simulating an acoustic imaging tool response, then resistivity logs or dielectric logs from a current well or adjacent wells can be used to synthesize the formation. Specifically, the reference logs can serve as a constraint on imaging properties selected for the synthesized formation.

In providing input through a GUI regarding imaging properties, a user can draw the outline of the formation layers or enter their dimensions through the GUI. Users may also directly enter values for the properties of the layers. For example, users may enter a range for the values for the properties of the layers and the properties may be changed randomly within the desired range. In another example, users may enter a mean value and a standard deviation for the values of the properties of the layers. In some cases, properties of the layers may be fully or partially randomized within a user-specified range that is input through the GUI.

The dispersive nature of the formation and mud may be ignored in generating the synthesized formation. Further, formation permittivity may be assumed to be complex and both the real and imaginary components of the synthesized formation can be generated. If the mud response is based on measurements, the dispersive nature of the mud properties may already be described by measurements taken at different frequencies. Similarly, if the formation response is based on experiments, the dispersive nature of the formation may be taken from the experiment that is closest to the desired profile. In examples, a synthesized formation that is closest to the formation created by the user may be selected.

A numerical electromagnetic solver may be utilized as a forward model for simulating the tool response. Specifically, when simulations are used to obtain tool response, then numerical electromagnetic solvers can be used to simulate the tool response. Numerical electromagnetic solvers may employ methods such as Finite Difference Time Domain (FDTD), Finite Element Method (FEM), and Method of Moments (MoM).

The response of the formation for the synthesized formation may be generated on demand. In other cases, to account for the significant computational time required by such a simulation, simulated responses may be stored in a library. Then, simulated responses for a tool operating in a specific synthesized medium may be generated by selecting the closest available point available in the library or performing a multi-dimensional interpolation. In the on-demand version, generated random media may be simulated in totality. That is, the whole of random media may be the input to the forward model. In the case of using the library response to simulate the response, the library may include responses for a homogenous (excluding the borehole) formation as the formation properties, mud properties, borehole radius and standoff are varied. Then, responses may be generated pixel-by-pixel with the simplifying assumption that the environmental properties immediately in front of an electrode are the only ones with a significant effect on the response.

Further a simple circuit description of a tool, such as the circuit-based model for electromagnetic imaging tools described herein, can be used to simulate tool response. Since such models are generally very fast, they may alleviate the need of a library and may be run on-demand. In some embodiments, analytical models may be calibrated based on actual tool responses to improve accuracy. Even the responses that were obtained using the more complicated computational models may be calibrated in some embodiments.

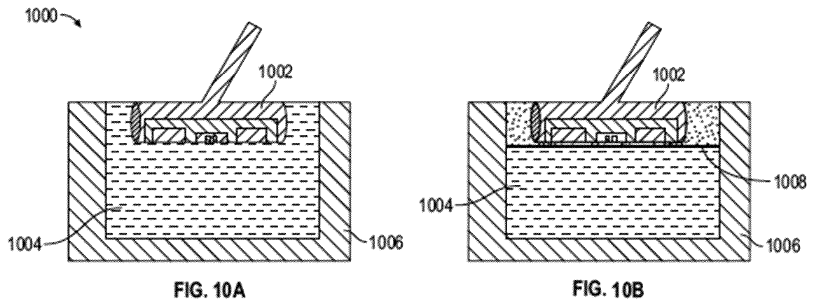

The disclosure now turns to a discussion of an example experiment that can be used to generate a library of tool responses and/or calibrate a model for simulating a tool response. Specifically, FIG. 10A illustrates a schematic representation of an experiment setup 1000 for generating a tool response. In the experiment setup 1000, a tool pad 1002 is placed in a fluid 1004 contained within an enclosure 1006. The fluid 1104 can have known properties. Specifically, the fluid's properties may be known through existing literature or through measurements. For example, a vector network analyzer may be used to determine the fluid's properties through a range of frequencies. Responses of the tool in the experiment setup 1000 may be stored and the experiment may be repeated for a range of formation properties.

FIG. 10B illustrates a schematic representation of an alternative experiment setup 1050. In the experiment setup 1050 shown in FIG. 10B, the tool pad 1002 is placed in the enclosure 1006 with a divider 1008 that separates the fluid 1004 from a remaining portion of an enclosed area defined by the enclosure 1006. The divider 1008 can be formed by an applicable layer or layers of material, such as a thin plastic film layer. The fluid 1004 can emulate the formation while the region formed by the divider 1008 can emulate a mud layer adjacent to the formation. The standoff of the pad 1002 can be simulated by putting slabs on the divider 1008. Specifically, the standoff from the formation may be changed by putting slabs of known thickness on the divider 1008 and letting the pad 1002 stand on the slabs. Such an arrangement may be more versatile and may give more realistic experimental responses by including the effect of mud. The properties of the mud and formation may be changed by either replacing the fluid 1004 with other fluids or by modifying the properties of the fluid 1004, e.g. by adding salt.

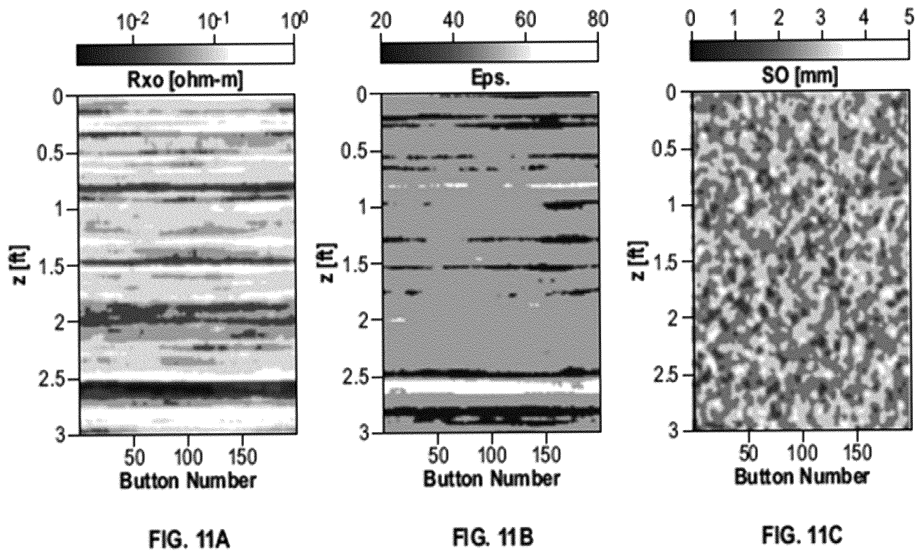

In using a library of tool responses to generate a simulated tool response, nearest neighbors of entries in the library can be used to generate a tool response for a specific synthetic formation, e.g. a randomly synthesized formation. FIGS. 11A-C represent tool response measurements that are synthesized using nearest neighbor entries in a library of tool responses. Specifically, FIG. 11A is a graph of an example of a resistivity profile of a synthetic medium that is generated based on the resistivity profile shown in FIG. 9A using the nearest neighbor approach. FIG. 11B is a graph of a relative permittivity profile of the synthetic medium that is generated based on the relative permittivity profile shown in FIG. 9B using the nearest neighbor approach. FIG. 11C is a standoff profile of the synthetic medium in conjunction with an electromagnetic imager tool operating in the synthetic medium using the nearest neighbor approach. In generating the responses shown in FIGS. 11A-C, the properties of a synthetic tool response are matched with the elements of a response in the library of responses on a specific basis, e.g. on a pixel-by-pixel basis.

A quantitative estimation component may be integrated with the job planner. Specifically, a quantitative estimation process can be used in comparing results of changing operational parameters and imaging properties on a tool response to true values of a formation. This comparison may be used to quantify the tool's performance by comparing the outputs of the quantitative estimation with the properties of the synthetic medium for the selected operational parameters and imaging properties.

An inversion approach or a machine learning based approach may be used for quantitative estimation. Specifically, a response of a tool may be simulated for inversion using an applicable forward model, such as the ones described herein. Then, the model parameters, including imaging properties, such as formation resistivity, formation permittivity, formation loss tangent, standoff, mud angle, mud permittivity, and mud resistivity, that minimize the difference between the response generated by the random or pseudo-random media, as described previously, and the model response corresponding to these parameters can be returned as the inversion output. An iterative process may be used for this purpose such as the Gauss-Newton method. The model responses may be simulated beforehand within a grid in the expected parameter range. This may be the same library used in creating the synthetic response of the tool for the given random media in some embodiments. Then, the response for the desired parameters may be found via multidimensional interpolation if it does not lie on the grid as mentioned before.

Equation 4 shows the essence of the inversion process; i.e. finding the parameter set (X̅, where the double overbar represents that parameter set may be a matrix) that minimizes the difference between the synthetic measurements of the imager (denoted as I̅) for the given random media created the job planner and the modeled response (I̅^{M}) corresponding to a given parameter set.

$${arg}_{{X}^{=}} min ‖ {I}^{=} = - {{I}^{=}}^{M} ( {X}^{=} ) ‖ \qquad Equation 4$$

It is noted that a vector is a special case of a matrix with a single row in the case of a column vector or a single column in the case of a row vector. Furthermore, matrices may be flattened to obtain vectors. Thus, these two terms are used interchangeably. Double bars denote the norm operation, i.e. minimization is in the least squares sense, which is one of the possible implementations. The function that is minimized is called the cost function. In some embodiments, a regularization term may be added to the cost function. Inversion may be done on a pixel-by-pixel basis, e.g. a parameter set may be solved for each measurement point on an image associated with operation of a tool. Further, in various embodiments, some of the parameters may be assumed to be constant, at least over a zone of the created random media. For example, mud parameters may be assumed to be a constant over the generated image. Regularization may also be used to constrain sudden jumps in inverted parameters. Note that the synthetic measurement matrix, and the corresponding modeled response, may include elements from each of the available frequencies. Ideally, number of measurements should be equal to or exceeding the number of unknowns. Otherwise, Equation 4 will be under-determined and a unique solution may not be obtained. In some cases, data from some frequencies may have higher weights in Error! Reference source not found. than other frequencies. For example, weights may be determined based on a noise estimate of the tool for a given frequency.

In other implementations, a regression function may be trained based on machine learning techniques using either simulated data or using measurements in known environments. Then, the response of a synthesized medium can be input into the regression function to find the unknown formation and/or mud parameters as outputs. Applicable machine learning techniques, such as neural networks, random forests or support vector regression techniques may be used for this purpose. In some implementations, more than one regression function may be trained. Output of these regression functions may be a subset of the unknown mud and/or formation parameters that are desired. Inputs of these regression functions may also be different. For example, responses generated for the random media of the job planner from a different subset of frequencies may be used as inputs for different regression functions based on the sensitivities of their outputs to these frequencies.

It is also possible to use a hybrid machine learning and inversion approach. The hybrid approach can maintain the higher accuracy of the inversion approach while improving the computational time required to perform the approach when compared to the pure inversion approach.

Noise can be added to the synthetic responses created for the synthesized formations to make the results more realistic. Users may change the level of noise and observe the effect on the quality of the raw measurements as well as the quantitative estimation results. Noise may be simulated as a Gaussian noise with a given mean and standard deviation value. Mean may be set to 0 while standard deviation may be estimated based on experimental data. Noise may be included in the responses in additive or multiplicative manner. Equation 5 is a representation of introducing noise in an additive manner.

$${{I}^{=}}^{N} = {I}^{=} = + A \times {G}^{=} ( {μ}^{=} , {σ}^{=} ) \qquad Equation 5$$

In Equation 5, A is the amplitude of the gaussian noise which may be dependent on the signal level and may be adjusted by the user. In various embodiments, A may be made a percentage of the mean or minimum signal level. In other cases, it may indicate an absolute quantity. G̅ denotes a Gaussian distribution with mean μ̅ and standard deviation σ̅. Overbars indicate the mean and standard deviation may be a function of parameters like frequency or button index. IN is the response matrix after the addition of the noise.

In various embodiments, a formation may be simulated to have a dip. A dip angle may be adjusted by a user from the GUI. Dipped formations on a cylindrical surface would show up as sinusoidal features when projected on an image. A random or pseudo-random media generator may first create sinusoidal layers with random thicknesses and then overlay further random variation on the layers. Alternatively, a random medium may be generated and may be tilted according to the desired tilt angle. This random medium may represent a cylindrical surface which may then be mapped to a flat image to create the sinusoidal features. In a similar manner, formations may be drawn by a user utilizing a sinusoidal feature of a certain amplitude corresponding to a specific dip angle or the generated formation may be tilted later according to the desired tilt angle.

In various embodiments, a radius of the curvature of the tool and the planned radius of the borehole will have a mismatch. This mismatch may be called a geometric factor. Further, some of the button electrodes on the tool may have a larger standoff than the others. For example, if the borehole radius is greater than the radius of the curvature of the tool, and assuming the tool is not tilted, center electrodes may touch the formation and the electrodes on the edges may have an inherent standoff. Borehole radius may be entered through the GUI in the job planner and may be calculated assuming a centered tool without tilt and incorporated in the calculation of the synthetic response of the tool. Users may be given the option to see the effects of unusual circumstances like a tilted pad.

Even without a mismatch between the tool and the borehole wall, different electrodes may behave differently due to their position in the array. This effect can also be known as a type of geometric factor. For example, currents of the center electrodes may be better focused while the electrodes on the edges may spread more. This inherent difference may already be taken care of if the data used in calculating the tool's response comes from experiments or accurate numerical modeling of the tool. Otherwise, if a simpler analytical formulation is used, this effect may be introduced empirically or through a calibration of the model as suggested earlier.

In other cases, users may have the ability to add other more specialized features on top of the generated formation. Such features may include vugs, fractures and breakouts. Such features may be created from basic shapes such as rectangles and circles whose dimensions, resistivities and locations may be adjusted through the GUI. In some implementations, these features may be pasted on the underlying formation and by right clicking on the feature its properties may be modified. In some cases, users may be able to drag and expand the edges of the shape to distort and change the shape, or draw a polyline on a plot as the boundary of the features. Multiple plots may be tied to each other in some embodiments such that the feature in one plot may show in the other plots as well. For example, a vug added to the formation resistivity image may also show up in the formation permittivity and standoff images. Users may change all the properties of the material by right clicking in one plot, or right clicking on different plots may give access to different properties. For example, editing permittivity of the feature may only be allowed in the formation permittivity image.

Other processing techniques may be incorporated into the job planner and their effects may be simulated. An example of such processing codes is a signal processing-based image enhancement algorithm that tries to reduce the effects of noise and other artifacts such as the geometric factor. Another processing algorithm that may be incorporated into the planner is a blending algorithm which tries to combine data from different frequencies based on a rule to obtain a combined image.

In various embodiments, a user may select a subset of operating frequencies among the possible operating frequencies of the tool. This may be done, as an example, through a drop-box down of the GUI. Selection of the frequencies may affect both the response of the tool at different frequencies as well as the results of the processing algorithms such as the quantitative estimation. By inspecting the results from different frequency combinations, a user may select the optimal frequencies for an upcoming job.

In various embodiments, a quality indicator in relation to a simulated tool response can be generated and provided to a user. For example, this quality indicator may be the norm of the differences between the ground truth properties, such as imaging properties including mud properties and standoff, and the corresponding properties provided by the quantitative estimation process. This quality indicator may be used to help users determine the optimal job parameters including operational parameters and adjustable imaging properties such as the mud properties. In some embodiments, a sweep over the job parameters may be performed to determine the job parameters with the highest quality based on the quality indicator. This optimal set of job parameters may be displayed to the user. In turn, a user can decide to implement these job parameters or use it as a starting point to further fine tune the parameters based on their preferences.

In various embodiments, pad pressure may be correlated with an increased rugosity since a reduced pressure will lead to reduced contact with the borehole wall. This relation may be quantified empirically in a test well or an experimental setup. Then, based on the selected pad pressure, the rugosity, e.g. standoff profile, of the generated random medium may be adjusted. It can be desirable to select the least amount of pad pressure that provides a certain minimum image quality since higher pad pressures may lead to higher stick and slip events and higher power requirements.

In various embodiments, effects of the logging speed may also be visualized through a job planner. Although increased logging speed may be desirable in reducing the total rig time, it can also lead to a lower signal-to-noise ratio. Thus, job planner may increase the noise level of the images based on an input logging speed. Resolution of the tool may also be adversely affected with an increased logging speed since the tool may have contributions from the surrounding pixels in the response. This latter affect may be visualized by applying a smoothing filter on the underlying generated response with high resolution.

In various embodiments, measurements from an earlier log, such as caliper measurements, may also be used to estimate the rugosity of the borehole. This information, along with pad pressure and logging speed, may be used to estimate the standoff variation of the tool. As mentioned above, the prediction of the effect of standoff may be done based on an empirical model determined using previous field or experimental data and pad pressure and/or logging speed can be adjusted until an acceptable image quality is obtained.

In various embodiments, a 2D formation profile can be assumed with the radial depth of the features ignored. However, features may also vary in the radial direction as well. The techniques described herein can be adapted to account for feature variance in the radial direction.

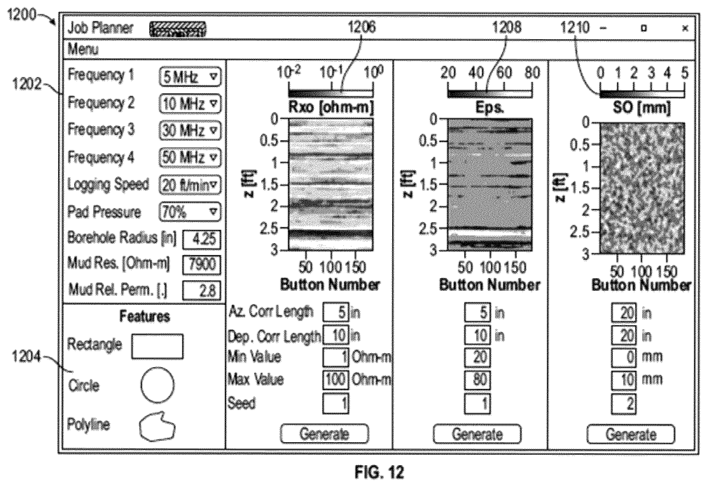

FIG. 12 illustrates an example GUI 1200 for controlling synthesis of a formation and simulation of a tool response in the synthesized formation. Region 1202 allows the selection of operational parameters such as operating frequencies, logging speed and pad pressure as well as other mud and borehole properties such as borehole radius, mud resistivity and mud relative permittivity. Region 1204 allows the user to add more specific features to the generated random media. Regions 1206, 1208, and 1210 provide functionalities for generating the properties of formation resistivity, formation relative permittivity and standoff, respectively. In this particular implementation, a random media generator can be used. A user can change the minimum and maximum values, correlation lengths in depth and azimuthal directions and the random seed used in the random media generation. Activating the generate button would allow the user to see the created random medium for each property. Other features may be accessed through the menu button. For example, tool version may be selected and responses of the imager for the selected frequencies may be plotted through the menu. Menu may also include other options such as the ability to add random noise to the generated images as well as applying processing algorithms and quantitative estimation.

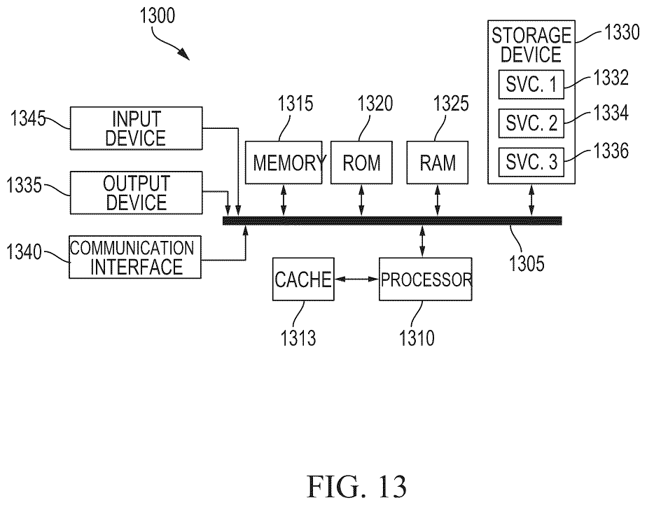

FIG. 13 illustrates an example computing device architecture 1300 which can be employed to perform various steps, methods, and techniques disclosed herein. Specifically, the computing device architecture can be integrated with the electromagnetic imaging tools described herein. Further, the computing device can be configured to implement the techniques of controlling borehole image blending through machine learning described herein.

As noted above, FIG. 13 illustrates an example computing device architecture 1300 of a computing device which can implement the various technologies and techniques described herein. The components of the computing device architecture 1300 are shown in electrical communication with each other using a connection 1305, such as a bus. The example computing device architecture 1300 includes a processing unit (CPU or processor) 1310 and a computing device connection 1305 that couples various computing device components including the computing device memory 1315, such as read only memory (ROM) 1320 and random access memory (RAM) 1325, to the processor 1310.

The computing device architecture 1300 can include a cache of high-speed memory connected directly with, in close proximity to, or integrated as part of the processor 1310. The computing device architecture 1300 can copy data from the memory 1315 and/or the storage device 1330 to the cache 1312 for quick access by the processor 1310. In this way, the cache can provide a performance boost that avoids processor 1310 delays while waiting for data. These and other modules can control or be configured to control the processor 1310 to perform various actions. Other computing device memory 1315 may be available for use as well. The memory 1315 can include multiple different types of memory with different performance characteristics. The processor 1310 can include any general purpose processor and a hardware or software service, such as service 1 1332, service 2 1334, and service 3 1336 stored in storage device 1330, configured to control the processor 1310 as well as a special-purpose processor where software instructions are incorporated into the processor design. The processor 1310 may be a self-contained system, containing multiple cores or processors, a bus, memory controller, cache, etc. A multi-core processor may be symmetric or asymmetric.

To enable user interaction with the computing device architecture 1300, an input device 1345 can represent any number of input mechanisms, such as a microphone for speech, a touch-sensitive screen for gesture or graphical input, keyboard, mouse, motion input, speech and so forth. An output device 1335 can also be one or more of a number of output mechanisms known to those of skill in the art, such as a display, projector, television, speaker device, etc. In some instances, multimodal computing devices can enable a user to provide multiple types of input to communicate with the computing device architecture 1300. The communications interface 1340 can generally govern and manage the user input and computing device output. There is no restriction on operating on any particular hardware arrangement and therefore the basic features here may easily be substituted for improved hardware or firmware arrangements as they are developed.

Storage device 1330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1325, read only memory (ROM) 1320, and hybrids thereof. The storage device 1330 can include services 1332, 1334, 1336 for controlling the processor 1310. Other hardware or software modules are contemplated. The storage device 1330 can be connected to the computing device connection 1305. In one aspect, a hardware module that performs a particular function can include the software component stored in a computer-readable medium in connection with the necessary hardware components, such as the processor 1310, connection 1305, output device 1335, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the disclosure include:

Statement 1. A method comprising generating a synthetic formation based on one or more imaging properties; simulating a tool response of an imaging tool operating according to one or more operational parameters to image the synthetic formation to generate a synthetic tool response; identifying a change to at least one of the one or more imaging properties and the one or more operational parameters; simulating the tool response of the imaging tool operating according to the change to at least one of the one or more imaging properties and the one or more operational parameters to generate a modified synthetic tool response; and reproducing a representation of the modified synthetic tool response to show an effect of the change to at least one of the one or more imaging properties and the one or more operational parameters on the tool response of the imaging tool.

Statement 2. The method of statement 1, wherein the imaging tool is one of an oil-based mud electromagnetic imaging tool, a water-based mud electromagnetic imaging tool, an acoustic imaging tool, or a density imaging tool.

Statement 3. The method of any of statements 1 and 2, wherein the synthetic formation is generated by a formation model generator that is a random or pseudo-random generator that generates random or pseudo-random variations on the one or more imaging properties and the one or more imaging properties comprise formation properties of at least one of formation resistivity and complex formation relative permittivity.

Statement 4. The method of any of statements 1 through 3, wherein the synthetic formation is generated based on data from reference logs.

Statement 5. The method of any of statements 1 through 4, wherein the synthetic formation is generated based on input from a user.

Statement 6. The method of any of statements 1 through 5, wherein the tool response of the imaging tool is simulated by a forward model that is run on-demand using a simulation code.

Statement 7. The method of any of statements 1 through 6, wherein the tool response of the imaging tool is simulated by a forward model that is applied based on previous simulation results for the imaging tool.

Statement 8. The method of any of statements 1 through 7, wherein the tool response of the imaging tool is simulated by a forward model that is applied based on measured responses for the imaging tool at varying imaging properties and a varying standoff.

Statement 9. The method of any of statements 1 through 8, wherein the tool response of the imaging tool is simulated by a forward model and simulating the tool response to generate either the synthetic tool response or the modified synthetic tool response during a simulation further comprises: identifying a previous simulation result or measured response of the imaging tool associated with the simulation based on corresponding imaging properties and operational parameters used in generating the simulation; and generating the simulation based on either the previous simulation result or the measured response of the imaging tool associated with the simulation.

Statement 10. The method of any of statements 1 through 9, wherein the tool response of the imaging tool is simulated by a forward model and simulating the tool response for either the synthetic formation or the modified synthetic formation during a simulation further comprises applying multidimensional interpolation to tool responses from known imaging properties to find corresponding tool responses at imaging properties used to generate the synthetic formation for the simulation.

Statement 11. The method of any of statements 1 through 10, further comprising: identifying one or more additional imaging properties; and simulating the tool response of the imaging tool based on the one or more additional imaging properties to generate the modified synthetic tool response.

Statement 12. The method of any of statements 1 through 11, wherein the one or more operational parameters comprise one of operating frequencies, logging speed, pad pressure, pad-to-borehole curvature mismatch, and measurement noise.

Statement 13. The method of any of statements 1 through 12, wherein the one or more imaging properties comprise formation and borehole properties wherein the formation properties comprise at least one of varying formation resistivity, and varying formation permittivity, borehole properties comprise mud properties and standoff and the mud properties further comprise at least one of varying mud permittivity, varying mud resistivity, and varying mud oil-to-water ratio.

Statement 14. The method of any of statements 1 through 13, further comprising providing functionalities for performing image enhancement on either or both the synthetic tool response and modified synthetic tool response.

Statement 15. The method of any of statements 1 through 14, further comprising providing functionalities for performing quantitative estimation on either or both the synthetic tool response and modified synthetic tool response.

Statement 16. The method of statement 15, wherein the quantitative estimation is performed through an inversion approach, a machine learning approach, or a hybrid machine learning and inversion approach.

Statement 17. The method of statement 15, further comprising comparing results of the one or more imaging properties obtained from quantitative estimation with the one or more imaging properties used in generating either or both the synthetic tool response and modified synthetic tool response to quantify an expected performance for either or both the change to the one or more imaging parameters and the change to the one or more operational parameters.

Statement 18. The method of statement 17, further comprising generating a quality indicator of either or both the synthetic tool response and the modified synthetic tool response based on a difference between results of the one or more imaging properties obtained from quantitative estimation with the one or more formation imaging properties used in generating either or both the synthetic tool response and modified synthetic tool response due to either or both the change to the one or more imaging properties and the change to the one or more operational parameters.

Statement 19. The method of statement 15, further comprising comparing results of the one or more imaging properties obtained from quantitative estimation with the one or more imaging properties used in generating either or both the synthetic tool response and modified synthetic tool response to quantify an expected performance for a given level of measurement noise.

Statement 20. A system comprising: one or more processors; and at least one computer-readable storage medium having stored therein instructions which, when executed by the one or more processors, cause the one or more processors to: generate a synthetic formation based on one or more imaging properties; simulate a tool response of an imaging tool operating according to one or more operational parameters to image the synthetic formation to generate a synthetic tool response; identify a change to at least one of the one or more imaging properties; simulate the tool response of the imaging tool operating according to the change to at least one of the one or more imaging properties to generate a modified synthetic tool response; access actual measurements made by the imaging tool in imaging a real formation; and compare the actual measurements to simulated measurements included in either or both the synthetic tool response and the modified synthetic tool response to aid in the interpretation of the tool response.

Statement 21. A system comprising: one or more processors; and at least one computer-readable storage medium having stored therein instructions which, when executed by the one or more processors, cause the one or more processors to: generate a synthetic formation based on one or more imaging properties; simulate a tool response of an imaging tool operating according to one or more operational parameters to image the synthetic formation to generate a synthetic tool response; identify a change to at least one of the one or more imaging properties and the one or more operational parameters; simulate the tool response of the imaging tool operating according to the change to at least one of the one or more imaging properties and the one or more operational parameters to generate a modified synthetic tool response; and reproduce a representation of the modified synthetic tool response to show an effect of the change to at least one of the one or more imaging properties and the one or more operational parameters on the tool response of the imaging tool.

Statement 22. A system comprising means for performing a method according to any of statements 1 through 19.

What is claimed is:

1. A method comprising:
generating a synthetic formation based on one or more imaging properties;
simulating a tool response of an imaging tool operating according to one or more operational parameters to image the synthetic formation to generate a synthetic tool response;
identifying a change to at least one of the one or more imaging properties and the one or more operational parameters;
simulating the tool response of the imaging tool operating according to the change to at least one of the one or more imaging properties and the one or more operational parameters to generate a modified synthetic tool response; and
reproducing a representation of the modified synthetic tool response to show an effect of the change to at least one of the one or more imaging properties and the one or more operational parameters on the tool response of the imaging tool.

2. The method of claim 1, wherein the imaging tool is one of an oil-based mud electromagnetic imaging tool, a water-based mud electromagnetic imaging tool, an acoustic imaging tool, or a density imaging tool.

3. The method of claim 1, wherein the synthetic formation is generated by a formation model generator that is a random or pseudo-random generator that generates random or pseudo-random variations on the one or more imaging properties and the one or more imaging properties comprise at least one of the formation properties of formation resistivity and complex formation relative permittivity.

4. The method of claim 1, wherein the synthetic formation is generated based on data from reference logs.

5. The method of claim 1, wherein the synthetic formation is generated based on input from a user.

6. The method of claim 1, wherein the tool response of the imaging tool is simulated by a forward model that is run on-demand using a simulation code.

7. The method of claim 1, wherein the tool response of the imaging tool is simulated by a forward model that is applied based on previous simulation results for the imaging tool.

8. The method of claim 1, wherein the tool response of the imaging tool is simulated by a forward model that is applied based on measured responses for the imaging tool at varying formation properties and a varying standoff.

9. The method of claim 1, wherein the tool response of the imaging tool is simulated by a forward model and simulating the tool response to generate either the synthetic tool response or the modified synthetic tool response during a simulation further comprises:
identifying a previous simulation result or measured response of the imaging tool associated with the simulation based on corresponding imaging properties and operational parameters used in generating the simulation; and
generating the simulation based on either the previous simulation result or the measured response of the imaging tool associated with the simulation.

10. The method of claim 1, wherein the tool response of the imaging tool is simulated by a forward model and simulating the tool response for either the synthetic formation or the modified synthetic formation during a simulation further comprises applying multidimensional interpolation to tool responses from known imaging properties to find corresponding tool responses at imaging properties used to generate the synthetic formation for the simulation.

11. The method of claim 1, further comprising:
identifying one or more additional imaging properties; and
simulating the tool response of the imaging tool based on the one or more additional imaging properties to generate the modified synthetic tool response.

12. The method of claim 1, wherein the one or more operational parameters comprise one of operating frequencies, logging speed, pad pressure, and pad-to-borehole curvature mismatch.

13. The method of claim 1, wherein the one or more imaging properties comprise formation and borehole properties wherein the formation properties comprise at least one of varying formation resistivity, and varying formation permittivity, borehole properties comprise mud properties and standoff and the mud properties further comprise at least one of varying mud permittivity, varying mud resistivity, and varying mud oil-to-water ratio.

14. The method of claim 1, further comprising providing functionalities for performing image enhancement on either or both the synthetic tool response and modified synthetic tool response.

15. The method of claim 1, further comprising providing functionalities for performing quantitative estimation on either or both the synthetic tool response and modified synthetic tool response.

16. The method of claim 15, wherein the quantitative estimation is performed through an inversion approach, a machine learning approach, or a hybrid machine learning and inversion approach.

17. The method of claim 15, further comprising:
comparing results of the one or more imaging properties obtained from quantitative estimation with the one or more imaging properties used in generating either or both the synthetic tool response and modified synthetic tool response to quantify an expected performance for either or both the change to the one or more imaging parameters and the change to the one or more operational parameters.

18. The method of claim 17, further comprising:
generating a quality indicator of either or both the synthetic tool response and the modified synthetic tool response based on a difference between results of the one or more imaging properties obtained from quantitative estimation with the one or more formation imaging properties used in generating either or both the synthetic tool response and modified synthetic tool response due to either or both the change to the one or more imaging properties and the change to the one or more operational parameters.

19. The method of claim 15, further comprising:
comparing results of the one or more imaging properties obtained from quantitative estimation with the one or more imaging properties used in generating either or both the synthetic tool response and modified synthetic tool response to quantify an expected performance for a given level of measurement noise.

20. A system comprising:
one or more processors; and
at least one computer-readable storage medium having stored therein instructions which, when executed by the one or more processors, cause the one or more processors to:
generate a synthetic formation based on one or more imaging properties;
simulate a tool response of an imaging tool operating according to one or more operational parameters to image the synthetic formation to generate a synthetic tool response;
identify a change to at least one of the one or more imaging properties;
simulate the tool response of the imaging tool operating according to the change to at least one of the one or more imaging properties to generate a modified synthetic tool response;
access actual measurements made by the imaging tool in imaging a real formation; and
compare the actual measurements to simulated measurements included in either or both the synthetic tool response and the modified synthetic tool response to aid in the interpretation of the tool response.

21. A system comprising:
one or more processors; and
at least one computer-readable storage medium having stored therein instructions which, when executed by the one or more processors, cause the one or more processors to:
generate a synthetic formation based on one or more imaging properties;
simulate a tool response of an imaging tool operating according to one or more operational parameters to image the synthetic formation to generate a synthetic tool response;
identify a change to at least one of the one or more imaging properties and the one or more operational parameters;
simulate the tool response of the imaging tool operating according to the change to at least one of the one or more imaging properties and the one or more operational parameters to generate a modified synthetic tool response; and
reproduce a representation of the modified synthetic tool response to show an effect of the change to at least one of the one or more imaging properties and the one or more operational parameters on the tool response of the imaging tool.
